(19) United States
(12) Patent Application Publication
(10) Pub. No.: US 2009/0121195 A1
(43) Pub. Date: May 14, 2009

(54) HIGH DIELECTRIC POLYMER COMPOSITE

(75) Inventors: Eun Sung Lee, Seoul (KR); Sang Mock Lee, Yongin-si (KR); Young Hun Byun, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/130,441

(22) Filed: May 30, 2008

(30) Foreign Application Priority Data
Nov. 14, 2007 (KR) 10-2007-0115981

(51) Int. Cl. H01B 1/00

(52) U.S. Cl. 252/503; 252/512; 252/513; 252/514; 252/519.33; 252/519.31; 252/511; 977/762; 977/742

(57) ABSTRACT

A high dielectric polymer composite having a high dielectric constant is disclosed herein. The high dielectric polymer composite includes a conductive material doped with oxidizable metal nanoparticles or metal oxide nanoparticles to decrease dielectric loss, and a surfactant having a head portion containing an acidic functional group to form a passivation layer that surrounds the conductive material, resulting in increased dielectric constant.

This application claims priority to Korean Patent Application No. 2007-115981, filed on Nov. 14, 2007, and all the benefits accruing therefrom under 35 U.S.C. § 119, the content of which is incorporated herein by reference in its entirety.

### BACKGROUND OF THE INVENTION

1. Field of the Invention

This disclosure is directed to a high dielectric polymer composite, and more particularly, to a high dielectric polymer composite, which comprises a conductive material doped with oxidizable metal nanoparticles or metal oxide, a surfactant having a head portion containing an acidic functional group, and a polymer resin, thus realizing a high dielectric constant.

2. Description of the Related Art

According to recent trends in electronic products industry, mobile electronics are dominating technological development and markets. Thus, intensive and extensive research and development have been made to decrease the size and weight of mobile products and increase the performance thereof.

In order to realize high-density surface mounting, a substrate is required to have fine via-holes and as small a wiring pitch as possible, and must be able to be subjected to a fabrication process. Further, IC packages should be miniaturized, pluralities of pins should be used, and passive parts, including condensers and resistors, should be miniaturized and surface-mounted. However, with the advancement of the miniaturization of passive devices, the manufacture and mounting thereof become more difficult, and thus the conventional process has many limitations.

To overcome such limitations, there have been proposed techniques for directly forming passive devices on or in a printed circuit board (“PCB”), instead of mounting them on the PCB. These techniques for embedding passive devices are characterized in that passive devices are disposed outside or inside the substrate using new materials and processes, thereby substituting for the functions of conventional chip resistors and chip capacitors. Accordingly, there is no need for chip parts of the passive devices to be mounted on the printed wiring board, thus realizing high density and high reliability. As the passive devices are embedded in the PCB through such techniques, the surface area of the substrate can be decreased, thereby making it possible to decrease the size and weight of products. Further, inductance is reduced, to thereby improve electrical performance, and furthermore, the number of solder joints is decreased, therefore increasing apparatus reliability and reducing the manufacturing cost.

Among the passive devices, the resistor and inductor, which may be formed through a polymer thick film (“PTF”) process, have some design drawbacks, but entail no great difficulty in terms of materials and manufacturing processes. However, in the case of the capacitor, it cannot be applied to fields requiring a high capacity, because a material having high capacitance and a manufacturing process for applying the material to a low-temperature process (i.e., less than about 260° C.) are not available. Typically, embedded condensers require capacity ranging from 1 pF to 1 μF, depending on the applications thereof. When a thin film process is used, high capacity may be achieved, but high-temperature annealing should be carried out. Furthermore, the produced ceramic thin film may easily break down when applied to an organic substrate. Further, the application to FR-4 or flex substrates is also limited, causing high cost of the manufacturing process. In contrast, the PTF process may be easily and inexpensively performed and may ensure high applicability to an organic substrate, but results in low dielectric capacity.

### BRIEF SUMMARY OF THE INVENTION

It is therefore desirable to achieve a high dielectric constant by use of the PTF process. Accordingly, disclosed herein is, in an embodiment, a high dielectric polymer composite having a high dielectric constant and a low heat loss.

Also disclosed herein is a capacitor comprising the high dielectric polymer composite.

Also in an embodiment, a high dielectric polymer composite is provided. The high dielectric polymer composite comprises a conductive material doped with oxidizable metal nanoparticles or metal oxide nanoparticles; a surfactant composed of a backbone, a tail portion, and a head portion connected to the backbone, the head portion containing an acidic functional group; and a polymer resin.

In another embodiment, a capacitor comprising the high dielectric polymer composite is provided.

### BRIEF DESCRIPTION OF THE DRAWINGS

The exemplary embodiments will be more clearly understood from the following detailed description taken in conjunction with the accompanying drawings, in which:

FIG. 1 is a transmission electron micrograph (“TEM”) illustrating an exemplary conductive material prepared in Preparative Example 1;

FIG. 2 is a scanning transmission electron micrograph (“STEM”) illustrating the exemplary conductive material prepared in Preparative Example 1;

FIG. 3 is a graph illustrating the results of energy dispersive X-ray (“EDX”) analysis of the exemplary conductive material prepared in Preparative Example 1; and

FIG. 4 is a proton nuclear magnetic resonance (“NMR”) spectrum of an exemplary surfactant prepared in Preparative Example 1.

### DETAILED DESCRIPTION OF THE INVENTION

Hereinafter, a detailed description will be given of example embodiments with reference to the accompanying drawings.

As used herein, the singular forms “a,” “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In accordance with one embodiment, a high dielectric polymer composite comprises a conductive material doped with oxidizable metal nanoparticles or metal oxide nanoparticles; a surfactant composed of a backbone and tail and head portions connected to the backbone, the head portion containing an acidic functional group; and a polymer resin.

In another embodiment, a method of preparing a dielectric having a high dielectric constant include enlarging the effective area or increasing the capacitance (effective dielectric constant) using a dielectric material having a high dielectric constant. When a material having an interconnection structure, such as carbon black, instead of metal powder, is used as a conductive material, it functions as an electrode in a state where it is dispersed in a polymer resin, thus enlarging the electrode area of the dielectric. In this case, although the interface between the conductive material and the polymer resin plays a role in enlarging the effective area, it entails the dielectric loss (tan δ) of the dielectric. Hence, in one embodiment, the dielectric loss is decreased by doping the conductive material with oxidizable metal nanoparticles or metal oxide nanoparticles. In this case, however, the dielectric constant is also decreased along with the decrease in the dielectric loss. This is because, although the conductive material is isolated by the oxidized film resulting from the doped metal nanoparticles or oxide to decrease the dielectric loss, it is not sufficient to serve as an electrode, and thus capacitance is not increased in proportion to the increase in the effective area. Accordingly, in order to prevent the decrease in the dielectric constant, which accompanies the decrease in the dielectric loss, a surfactant having a head portion containing an acidic functional group is additionally used to thus form a passivation layer that surrounds the conductive material in the polymer resin. Thereby, electrical conduction or percolation, which may be caused by contact between the particles of the conductive material, is prevented, thereby minimizing the decrease in the capacitance of the dielectric.

The high dielectric polymer composite includes the conductive material doped with oxidizable metal nanoparticles or metal oxide nanoparticles, thus increasing the effective area and simultaneously decreasing the dielectric loss. The high dielectric polymer composite further includes the surfactant having a head portion containing an acidic functional group, thereby increasing the dielectric capacitance and thus resulting in a dielectric composite having a high dielectric constant.

Below, individual components of the high dielectric polymer composite are described in greater detail.

Conductive Material Doped with Oxidizable Metal Nanoparticles or Metal Oxide Nanoparticles

The high dielectric polymer composite includes a conductive material doped with oxidizable metal nanoparticles or metal oxide nanoparticles. As the conductive material, a material having an interconnection structure, such as carbon black, is used instead of metal powder, thus enlarging the electrode area of the dielectric. Further, in order to decrease the dielectric loss of the dielectric, the conductive material is doped with the oxidizable metal nanoparticles or metal oxide nanoparticles.

The conductive material includes carbon black, carbon nanotubes, carbon nanowires, carbon fibers, graphite, and a mixture thereof.

The metal nanoparticles or metal oxide nanoparticles, which are doped on the conductive material, include an easily oxidizable material such as a base metal. Examples of the base metal include, but are not limited to, one or more selected from the group consisting of nickel, zinc, copper, iron, mercury, silver, platinum, gold, tin, lead, aluminum, oxides thereof, and mixtures thereof.

### Surfactant

The high dielectric polymer composite includes a surfactant composed of a backbone, and tail and head portions connected to the backbone. The head portion contains an acidic functional group.

The head portion of the surfactant may contain one or more acidic functional groups selected from the group consisting of —COOH, —PO₄H₂, —PO₃H, —PO₄H⁻, —SH, —SO₃H, and —SO₄H.

The tail portion of the surfactant has one or more hydrophilic or hydrophobic side chains, which are connected to the backbone.

The head portion, containing the acidic functional group, has a high affinity for the oxidizable metal material, thus forming a chemical bond through a reaction therebetween. In contrast, the tail portion, containing one or more hydrophilic or hydrophobic side chains, has a high affinity for the polymer resin. Hence, in the polymer-conductive material composite, the head portion of the surfactant is linked with the conductive material doped with the metal oxide nanoparticles, and the tail portion thereof is oriented toward the polymer resin, thereby enabling the formation of a passivation layer that surrounds the conductive material. Because the surfactant having the head portion containing the acidic functional group forms the passivation layer that surrounds the conductive material, such as carbon black or carbon nanotubes, in the polymer resin, electrical conduction or percolation due to contact between the particles of the conductive material is prevented, thereby providing a high dielectric constant.

The head portion of the surfactant is linked with the conductive material doped with the metal oxide nanoparticles through a chemical reaction. Thus, the head portions of the surfactant are arranged around the conductive material, and the tail portions, having affinity to the polymer resin, radially extend from the head portions, so that the conductive material is efficiently dispersed in the dispersion medium. Through the chemical reaction, for example, acid-base interaction between —PO₄H₂, which is a functional group of the head portion of the surfactant, and NiO, which is doped on the conductive material, a salt is formed. In particular, as the acidic functional group of the head portion of the surfactant, a ferroelectric component (e.g., —OPO(OH)₂) does not bind with the acidic conductive material such as carbon black and thus does not function as the passivation layer of the surfactant. However, in the composite including the conductive material doped with the oxidizable metal nanoparticles or metal oxide particles, strong acid-base interaction occurs between the metal nanoparticles or metal oxide nanoparticles, which are doped on the conductive material, and the ferroelectric functional group, thus enabling to introduce the ferroelectric acidic functional group, thereby increasing the dielectric constant of the composite.

Examples of the head portion of the surfactant include, but are not limited to, groups represented by Formulas 1 and 2 below:

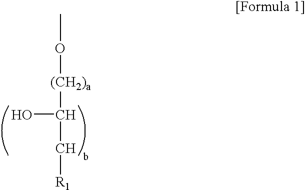

wherein R₁ is one or more selected from the group consisting of —COOH, —PO₄H₂, —PO₃H, —PO₄H⁻, —SH, —SO₃H, and —SO₄H; a ranges from 1 to 5; and b ranges from 1 to 10.

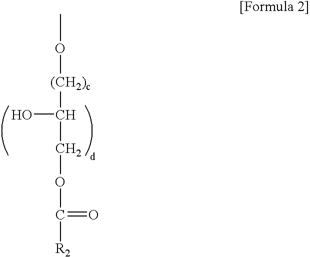

wherein R₂ is one or more selected from the group consisting of —COOH, —PO₄H₂, —PO₃H, —PO₄H⁻, —SH, —SO₃H, and —SO₄H; c ranges from 1 to 5; and d ranges from 1 to 10.

Examples of the backbone of the surfactant include, but are not limited to, one or more selected from the group consisting of polyacryl, polyurethane, polystyrene, polysiloxane, polyether, polyisobutylene, polypropylene, and polyepoxy.

Examples of the tail portion of the surfactant include, but are not limited to, one or more selected from the group consisting of compounds represented by Formulas 3 and 4 below:

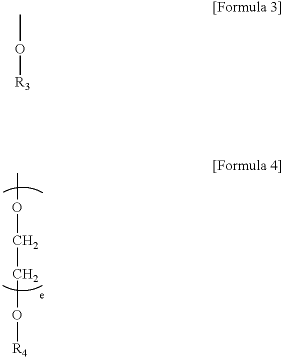

in Formulas 3 and 4, R₃ is a C_{1˜30} alkyl group, a C_{2˜30} alkene group, or a C_{2˜30} alkyne group; R₄ is a C_{1˜10}-alkyl group, a C_{2˜10} alkene group, a C_{2˜10} alkyne group, or a C_{6˜30} aryl group; and e ranges from 1 to 20.

The surfactant of the example embodiments may be represented by Formulas 5 to 9 below:

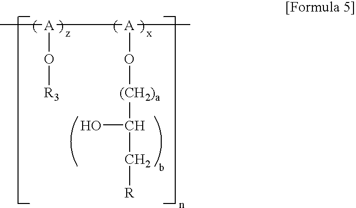

wherein each A is independently a backbone group, including acryl, urethane, styrene, siloxane, ether, isobutylene, propylene, or epoxy; R₁ is one or more selected from the group consisting of —COOH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; x and z each range from 1 to 50; a ranges from 1 to 5; b ranges from 1 to 10; and n ranges from 1 to 50. It will be understood for all such A groups disclosed herein that where more than one A is present as a backbone group, the different A groups are copolymerizable groups.

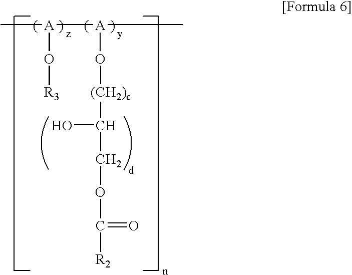

wherein each A is independently a backbone group, including acryl, urethane, styrene, siloxane, ether, isobutylene, propylene or epoxy; R₂ is one or more selected from the group consisting of —COOH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; y and z each range from 1 to 50; c ranges from 1 to 5; d ranges from 1 to 10; and n ranges from 1 to 50.

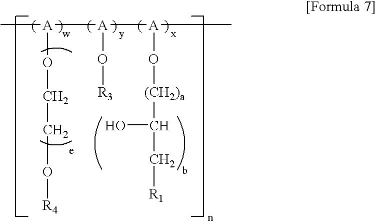

wherein each A is independently a backbone group, including acryl, urethane, styrene, siloxane, ether, isobutylene, propylene or epoxy; R₁ is one or more selected from the group consisting of —COOH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; R₄ is a C_{1˜10} alkyl group, a C_{2˜10} alkene group, a C_{2˜10} alkyne group, or a C_{6˜30} aryl group; x, y and w each ranges from 1 to 50; a ranges from 1 to 5; b ranges from 1 to 10; e ranges from 1 to 20; and n ranges from 1 to 50.

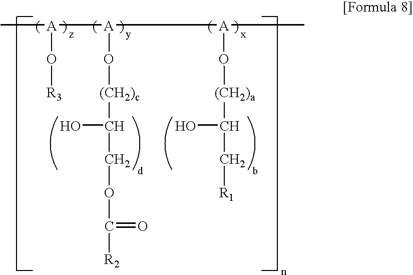

wherein each A is independently a backbone group, including acryl, urethane, styrene, siloxane, ether, isobutylene, propylene or epoxy; R₁ and R₂ are each one or more selected from the group consisting of —COOH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; x, y and z each ranges from 1 to 50; a and c range from 1 to 5; b and d range from 1 to 10; and n ranges from 1 to 50.

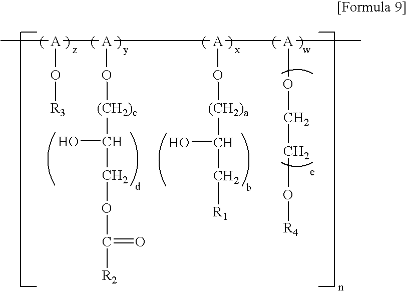

wherein each A is independently a backbone group, including acryl, urethane, styrene, siloxane, ether, isobutylene, propylene or epoxy; R₁ and R₂ are each one or more selected from the group consisting of —COOH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; R₄ is a C_{1˜10} alkyl group, a C_{2˜10} alkene group, a C_{2˜10} alkyne group, or a C_{6˜30} aryl group; x, y, z and w each ranges from 1 to 50; a and c range from 1 to 5; b and d range from 1 to 10; e ranges from 1 to 20; and n ranges from 1 to 50.

Examples of the surfactant include, but are not limited to, compounds represented by Formulas 10 and 11 below:

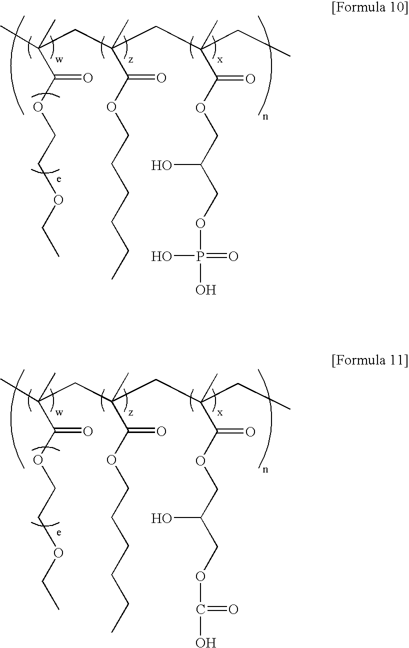

wherein in Formulas 10 and 11, x, y and z each ranges from 1 to 50; and n ranges from 1 to 50.

The surfactant has a number averaged molecular weight (Mn) of about 500 to about 10,000.

The surfactant may be prepared by reacting one or more compounds selected from compounds represented by Formulas 12 and 13 with a compound represented by Formula 14 in the presence of a polymerization initiator, thereby obtaining a copolymer. Then, the copolymer is reacted with a monomer in the presence of an acid catalyst to form one or more head portions.

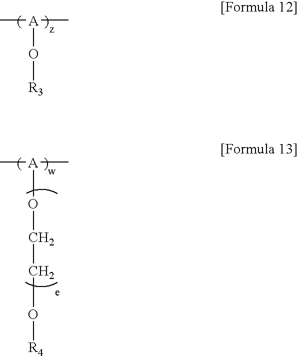

wherein, in Formulas 12 and 13, each A is independently a backbone group, including acryl, urethane, styrene, siloxane, ether, isobutylene, propylene or epoxy; R₃ is a C_{1˜30} alkyl group, a C_{2˜30} alkene group, or a C_{2˜30} alkyne group; R₄ is a C_{1˜10}-alkyl group, a C_{2˜10} alkene group, a C_{2˜10} alkyne group, or a C_{6˜30} aryl group; z and w each ranges from 1 to 50; and e ranges from 1 to 20.

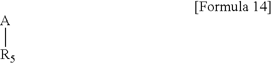

Here, A is a backbone formed of acryl, urethane, styrene, siloxane, ether, isobutylene, propylene or epoxy; and R₅ is an epoxy group substituted with a C_{1˜10}-alkyl group, a C_{2˜10} alkene group, a C_{2˜10} alkyne group, or a C_{6˜30} aryl group.

Examples of the monomer for forming one or more head portions include, but are not limited to, one or more selected from the group consisting of thiol compounds, phosphoric acid compounds, and sulfonic acid compounds.

Examples of the polymerization initiator include, but are not limited to, methyl trimethylsilyl dimethylketene acetal, potassium persulfate, hydrogen peroxide, cumyl hydroperoxide, di-tert butyl peroxide, dilauryl peroxide, acetyl peroxide, benzoyl peroxide, and azobisisobutyronitrile (“AIBN”).

Hereafter, a method of synthesizing the surfactant is described in greater detail. As shown in Reaction 1 below, as monomers for the tail portion, polyethylene glycol methacrylate, hexyl methacrylate, and glycidyl methacrylate for reaction with the head portion are subjected to Group Transfer Polymerization (“GTP”), thereby synthesizing the tail portion of the surfactant. In this case, in order to change the type of side chain thereof, a starting material containing a different type of side chain may be used.

The synthesized tail portion is reacted with the above monomer for forming the head portion to thereby obtain the surfactant, in which the head portion and the tail portion are connected to the backbones. The reaction is conducted through the additional reaction of an epoxy group and an acid in the presence of an acid or an ammonium salt catalyst. In Reaction 1 below, the monomer usable for the reaction to form the head portion is exemplified by phosphoric acid (H₃PO₄) or phosphorus pentoxide (P₂O₅). The reaction is performed at a temperature ranging from room temperature to 130° C. for a period of time ranging from 30 minutes to 15 hours under atmospheric pressure, followed by conducting heating and refluxing and removing the solvent at reduced pressure, thereby obtaining a desired surfactant.

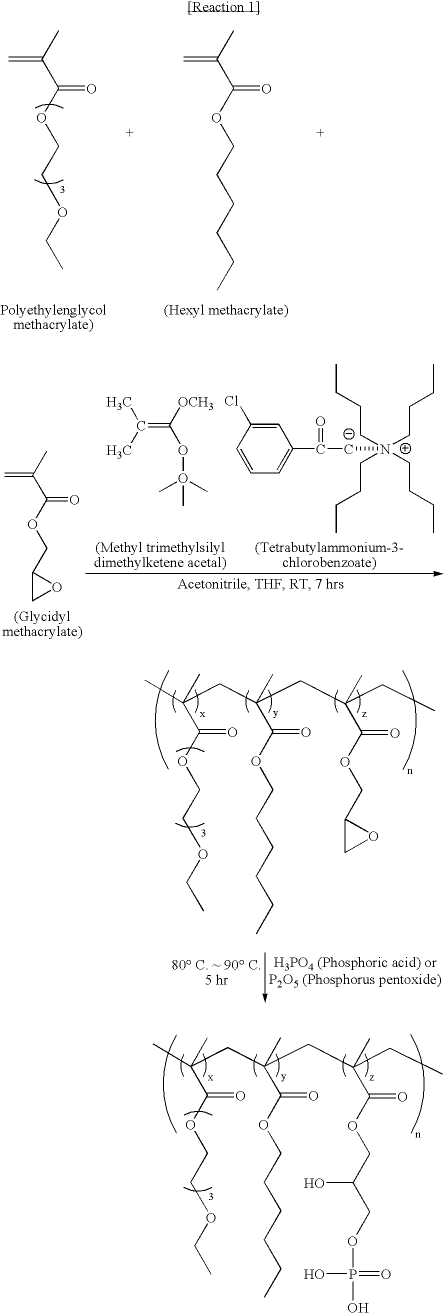

The surfactant is used in an amount of 10 to 80 parts by weight based on 100 parts by weight of the conductive material.

### Polymer Resin

Examples of the polymer resin included in the high dielectric polymer composite include, but are not limited to, one or more selected from the group consisting of epoxy, polyimide, silicon polyimide, silicone, polyurethane, benzocyclobutene.

The polymer resin is used in an amount of 50 to 99 vol % based on the total volume of the high dielectric polymer composite.

A binder or other organic additives may be added to the high dielectric polymer composite.

The high dielectric polymer composite is prepared by mixing the conductive material, the surfactant, and the polymer resin using a stirring device or a mixing device, such as a sonicator, a homogenizer, a spiral mixer, a planetary mixer, a disperser, or a hybrid mixer.

The high dielectric polymer composite is mixed with a solvent. Thereafter, the resultant mixture may be applied to a substrate through a coating process, including spin coating, electrophoretic deposition, casting, ink-jet printing, spraying, or off-set printing.

In another embodiment, the high dielectric polymer composite is applied to a capacitor. In the capacitor, the high dielectric polymer composite is used as a dielectric between electrodes facing each other. The high dielectric polymer can be applied not only to a general capacitor structure but also to a laminated capacitor structure.

The high dielectric polymer composite may be used for capacitors, and may also be used as material for electron guns or electrodes of field emission displays (“FEDs”), material for transparent electrodes of FEDs or liquid crystal displays, and light-emitting material, buffering material, electron transporting material, and hole transporting material for organic electroluminescence devices.

A better understanding of the exemplary embodiments will be described in more detail with reference to the following examples, which are for the purpose of illustration only and are not to be construed as limiting the scope of the invention.

### EXAMPLES

### Preparative Example 1

### Synthesis of Carbon Black doped with NiO Nanoparticles

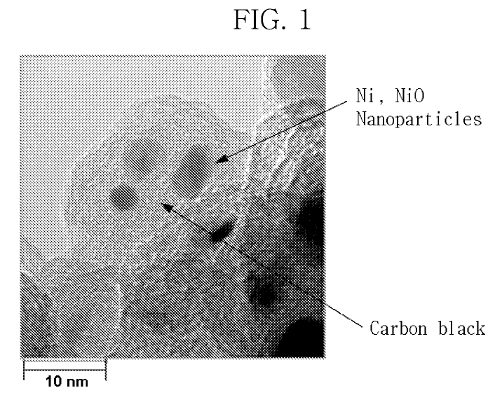

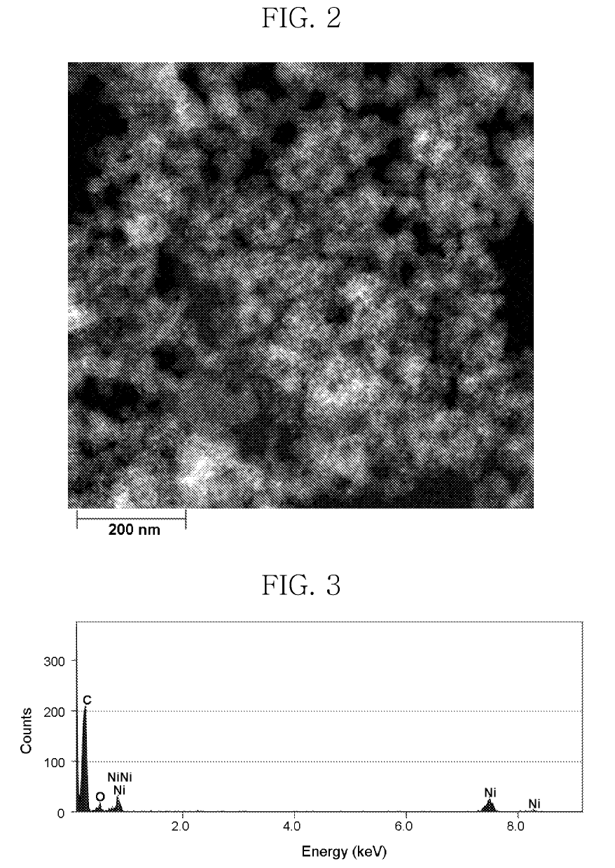

100 ml of tetrahydrofuran (THF) was added to 3.5 g of carbon black (Ketjen black 300, Mitsubishi) to prepare a slurry solution. 6.565 g (22.55 mmol) of Ni(acetyl acetone)₂ and 1.56 g (22.55 mol) of ethanolamine were dissolved in 100 ml of THF. This solution was added to the slurry solution such that the amount of Ni was 30 wt % based on the amount of carbon black. Thereafter, the reaction temperature was increased to 70° C., and stirring was conducted for 5 hours. Subsequently, the solvent was removed under the flow of nitrogen at the above reaction temperature, thus obtaining carbon black in which the Ni sol compound was uniformly distributed. Thereafter, baking was conducted at 400° C. for 6 hours in a nitrogen atmosphere, thus preparing 5 g of carbon black doped with Ni or NiO. A transmission electron microscopy (TEM) micrograph of the carbon black doped with Ni or NiO is shown in FIG. 1, and a scanning transmission electron microscopy (“STEM”) micrograph thereof is shown in FIG. 2. The results of energy dispersive X-ray (“EDX”) analysis of the carbon black are shown in FIG. 3.

It can be seen from FIGS. 1 to 3 that the carbon black is uniformly doped with Ni or NiO nanoparticles having an average particle size (longest dimension) measurable in nanometers (maximum: up to 50 nm).

### Preparative Example 2

### i) Synthesis of Tail Portion

The composition ratio of polyethylene glycol methacrylate, hexyl methacrylate and glycidyl methacrylate was set to 1:1:1. For the synthesis of a tail portion as a block copolymer having an expected number averaged molecular weight of 2,000, an initiator, for example, methyl trimethylsilyl dimethylketene acetal (3.48 g, 20 mmol), and a catalyst, for example, tetrabutylammonium-3-chlorobenzoate (0.07 g, 0.17 mmol), were dissolved in acetonitrile (1 ml) and THF (10 ml). Then, this solution was placed in a round-bottom flask and then stirred for 30 minutes using magnetic stirring bars. The stirred solution was slowly added with monomers, for example, polyethyleneglycol methacrylate (6.603 g, 7.5 mmol), hexyl methacrylate (4.569 g, 7.5 mmol) and glycidyl methacrylate (3.816 g, 7.5 mmol), and then allowed to react for 7 hours. After that, the disappearance of the monomers was confirmed through gas chromatography.

### ii) Introduction of Head Portion

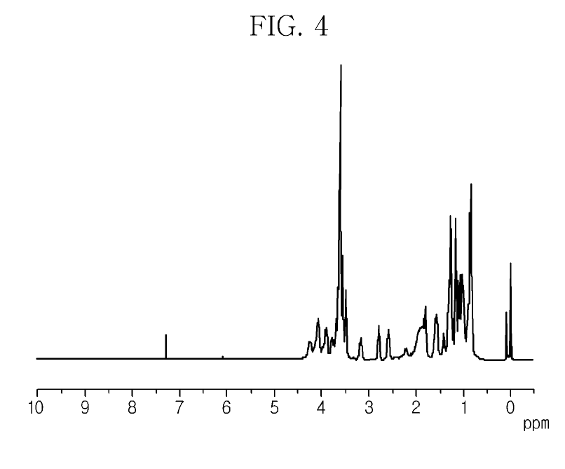

A catalyst, for example, tetraethyl ammonium chloride (0.8 g, 4.82 mmol), was added thereto in a state of being dissolved in acetonitrile (0.5 ml). Thereafter, phosphoric acid (H₃PO₄) was added in an equivalent amount. Subsequently, the reaction solution was allowed to react at 90° C. for 4 hours under atmospheric pressure, and the solvent was removed at reduced pressure, thus obtaining a surfactant. The NMR graph of the surfactant is shown in FIG. 4.

### Example 1

0.268 g of the carbon black prepared as above in Preparative Example 1 and 0.072 g of the surfactant prepared as above in Preparative Example 2 were mixed with 1.557 g of 3,4-epoxycyclohexylmethyl-3,4-epoxycyclohexanecarboxylate (Aldrich), 1.051 g of hexahydro-4-methylphthalic anhydride (Aldrich), and 0.005 g of 1-methylimidazole (Aldrich), to thereby preparing a paste.

### Comparative Example 1

A composite was prepared in the same manner as in Example 1, with the exception that carbon black (Ketjen black 300, available from Mitsubishi), which is a non-doped conductive material, was used, and the surfactant was not added.

### Comparative Example 2

A composite was prepared in the same manner as in Example 1, with the exception that the surfactant was not added.

The dielectric constant and the dielectric loss of the composites obtained in Example 1 and Comparative Examples 1 and 2 were measured for an average measurement time of 4 sec/point at a frequency ranging from 10 kHz to 10 MHz using a Hewlett-Packard HP 4194A impedance analyzer. Under conditions where the applied voltage was set within the range from −3.0 to 3.0 and the applied voltage interval was set to 0.10, capacitance was measured. Then, the dielectric constant was calculated using the following equations. In particular, in cases where the vol % of carbon black in the example and the comparative example was 2.8 and 3.1 respectively (carbon black total amount: 0.268 g and 0.298 g respectively), the dielectric constant and the dielectric loss were measured at a frequency of 1 MHz. The results are shown in Table 1 below.

$$\begin{matrix}{ɛ}_{0} = 8.854 \times {10}^{- 12} [ F / m ] \\ r = 150 \times {10}^{- 6} [ m ] \\ {ɛ}_{r} = \frac{Cd}{{ɛ}_{0} A} = \frac{Cd}{{ɛ}_{0} π {r}^{2}}\end{matrix}$$

Table 1 below shows the dielectric constant and the dielectric loss of the composites obtained in Example 1 and Comparative Examples 1 and 2.

TABLE 1

| | Carbon | | | | |
|---|---|---|---|---|---|
| | Black | | | Dielectric | Dielectric |
| | Vol % | Doping | Surfactant | Constant | Loss (%) |
| Ex. 1 | 2.8 | ◯ | ◯ | 41331 | 244.0 |
| | 3.1 | ◯ | ◯ | 36983 | 260.5 |
| Comp. Ex. 1 | 2.8 | X | X | 18820 | 206.6 |
| | 3.1 | X | X | 47721 | 314.85 |
| Comp. Ex. 2 | 2.8 | ◯ | X | 7411 | 174.9 |
| | 3.1 | ◯ | X | 10395 | 184.4 |

As is apparent from Table 1, the doping effect of the conductive material and the effect of the surfactant containing the acidic function group can be seen. In Comparative Example 1 using the non-doped carbon black and the surfactant, as the amount of the carbon black was increased, the dielectric constant was increased, but the dielectric loss was also increased. In Comparative Example 2 where the doped carbon black was used, the dielectric loss was decreased but the dielectric constant was considerably decreased. However, in Example 1 where both the doped carbon black and the surfactant were used, it can be seen that the dielectric constant was high and the dielectric loss was relatively decreased.

That is, the high dielectric polymer composite includes the conductive material doped with the oxidizable metal nanoparticles or metal oxide nanoparticles, thus decreasing the dielectric loss. Furthermore, the surfactant having the head portion containing the acidic functional group is included, and thus a passivation layer is formed so as to surround the conductive material, thereby preventing the generation of electrical conduction or percolation due to contact between the particles of the conductive material. Thus, a high dielectric constant can be achieved. Therefore, the high dielectric polymer composite may be used to realize superior capacitors, and may contribute to a decrease in the size and weight of mobile electronic devices.

Although example embodiments have been disclosed for illustrative purposes, those skilled in the art will appreciate that various modifications, additions and substitutions are possible, without departing from the scope and spirit of the invention as defined by the appended claims.

What is claimed is:

1. A high dielectric polymer composite, comprising:
a conductive material doped with oxidizable metal nanoparticles or metal oxide nanoparticles;
a surfactant comprising a backbone and tail and head portions connected to the backbone, the head portion containing an acidic functional group; and
a polymer resin.

2. The polymer composite of claim 1, wherein the metal nanoparticles or metal oxide nanoparticles comprise one or more base metals selected from the group consisting of nickel, zinc, copper, iron, mercury, silver, platinum, gold, tin, lead, aluminum, oxides thereof, and mixtures thereof.

3. The polymer composite of claim 1, wherein the conductive material comprises one or more selected from a group consisting of carbon black, carbon nanotubes, carbon nanowires, carbon fiber, and graphite.

4. The polymer composite of claim 1, wherein the backbone of the surfactant is one or more selected from a group consisting of polyacrylate, polyurethane, polystyrene, polysiloxane, polyether, polyisobutylene, polypropylene and polyepoxy.

5. The polymer composite of claim 1, wherein the acidic functional group of the head portion of the surfactant comprises one or more selected from a group consisting of —COOH, —PO₄H₂, —PO₃H, —PO₄H⁻, —SH, —SO₃H, and —SO₄H.

6. The polymer composite of claim 1, wherein the head portion of the surfactant is one or more selected from a group consisting of compounds represented by Formulas 1 and 2 below: 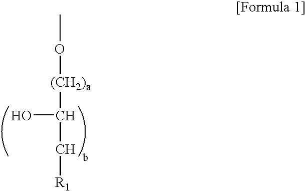
wherein R₁ is one or more selected from a group consisting of —COOH, —PO₄H₂, —PO₃H, —PO₄H⁻, —SH, —SO₃H, and —SO₄H,
a ranges from 1 to 5, and
b ranges from 1 to 10; and 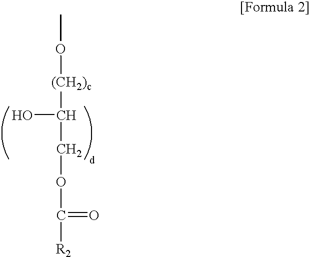
wherein R₂ is one or more selected from a group consisting of —COOH, —PO₄H₂, —PO₃H, —PO₄H⁻, —SH, —SO₃H, and —SO₄H,
c ranges from 1 to 5, and
d ranges from 1 to 10.

7. The polymer composite of claim 1, wherein the tail portion of the surfactant is one or more selected from a group consisting of compounds represented by Formulas 3 and 4 below: 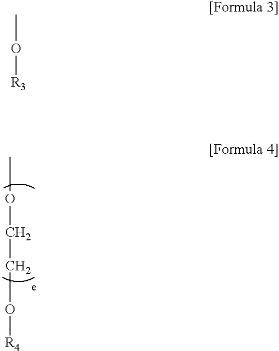
in Formulas 3 and 4, R₃ is a C_{1˜30} alkyl group, a C_{2˜30} alkene group, or a C_{2˜30} alkyne group,
R₄ is a C_{1˜10}-alkyl group, a C_{2˜10} alkene group, a C_{2˜10} alkyne group, or a C_{6˜30} aryl group, and
e ranges from 1 to 20.

8. The polymer composite of claim 1, wherein the surfactant is represented by Formulas 5 to 9 below: 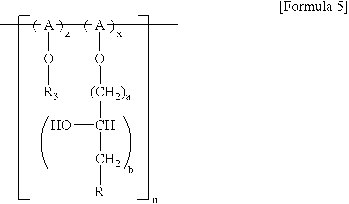
wherein each A is independently a backbone group, comprising acryl, urethane, styrene, siloxane, ether, isobutylene, propylene or epoxy,
R₁ is one or more selected from a group consisting of —COOH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
x and z each ranges from 1 to 50,
a ranges from 1 to 5,
b ranges from 1 to 10, and
n ranges from 1 to 50; 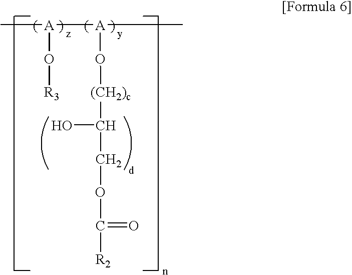
wherein each A is independently a backbone group, comprising acryl, urethane, styrene, siloxane, ether, isobutylene, propylene or epoxy,
R₂ is one or more selected from a group consisting of —COOH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
y and z each ranges from 1 to 50,
c ranges from 1 to 5,
d ranges from 1 to 10, and
n ranges from 1 to 50; 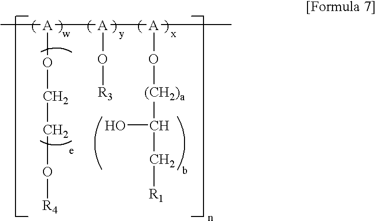
wherein each A is independently a backbone group, comprising acryl, urethane, styrene, siloxane, ether, isobutylene, propylene or epoxy,
R₁ is one or more selected from a group consisting of —COOH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
R₄ is a C_{1˜10} alkyl group, a C_{2˜10} alkene group, a C_{2˜10} alkyne group, or a C_{6˜30} aryl group,
x, y and w each ranges from 1 to 50,
a ranges from 1 to 5,
b ranges from 1 to 10,
e ranges from 1 to 20, and
n ranges from 1 to 50; 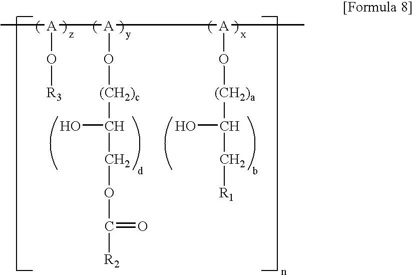
wherein each A is independently a backbone group, comprising acryl, urethane, styrene, siloxane, ether, isobutylene, propylene or epoxy,
R₁ and R₂ are each one or more selected from a group consisting of —COOH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
x, y and z each ranges from 1 to 50,
a and c range from 1 to 5,
b and d range from 1 to 10, and
n ranges from 1 to 50; and 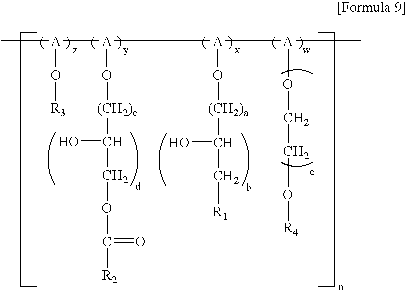
wherein each A is independently a backbone group, comprising acryl, urethane, styrene, siloxane, ether, isobutylene, propylene or epoxy,
R₁ and R₂ are each one or more selected from a group consisting of —COOH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
R₄ is a C_{1˜10} alkyl group, a C_{2˜10} alkene group, a C_{2˜10} alkyne group, or a C_{6˜30} aryl group,
x, y, z and w each ranges from 1 to 50,
a and c range from 1 to 5,
b and d range from 1 to 10,
e ranges from 1 to 20, and
n ranges from 1 to 50.

9. The polymer composite of claims 1, wherein the surfactant is represented by Formulas 10 and 11 below: 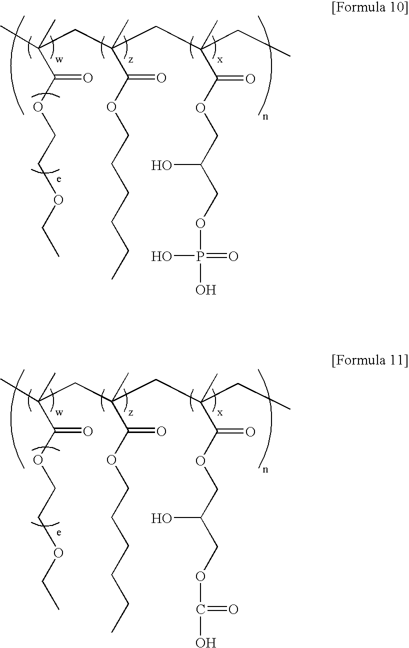
wherein x, y and z each ranges from 1 to 50, and
n ranges from 1 to 50.

10. The polymer composite of claim 1, wherein the surfactant has an average molecular weight ranging from 500 to 10,000.

11. The polymer composite of claim 1, wherein the polymer resin is one or more selected from a group consisting of epoxy resin, polyimide resin, silicon polyimide resin, silicone resin, polyurethane, benzocyclobutene, and a mixture thereof.

12. The polymer composite of claim 1, wherein the surfactant is used in an amount of 10-80 parts by weight based on 100 parts by weight of the conductive material; and the polymer resin is used in an amount of 50-99 vol % based on a total volume of the high dielectric polymer composite.

13. A capacitor comprising the high dielectric polymer composite of claim 1.

14. A capacitor comprising the high dielectric polymer composite of claim 2.

15. A capacitor comprising the high dielectric polymer composite of claim 3.

16. A capacitor comprising the high dielectric polymer composite of claim 4.

17. A capacitor comprising the high dielectric polymer composite of claim 5.

18. A capacitor comprising the high dielectric polymer composite of claim 6.

19. A capacitor comprising the high dielectric polymer composite of claim 7.

20. A capacitor comprising the high dielectric polymer composite of claim 8.
